(19) United States
(12) Patent Application Publication
(10) Pub. No.: US 2024/0377028 A1
(43) Pub. Date: Nov. 14, 2024

(54) HYDROGEN ENRICHED GAS STORAGE

(71) Applicant: SAUDI ARABIAN OIL COMPANY, Dhahran (SA)

(72) Inventors: Abdulaziz S. Al-Qasim, Dammam (SA); Ali Yousef, Dhahran (SA)

(73) Assignee: SAUDI ARABIAN OIL COMPANY, Dhahran (SA)

(21) Appl. No.: 18/315,671

(22) Filed: May 11, 2023

(51) Int. Cl. F17C 1/00

(52) U.S. Cl. CPC F17C 1/007; F17C 2221/012; F17C 2221/033; F17C 2223/0123; F17C 2265/012; F17C 2265/025

(57) ABSTRACT

A method for subsurface gas storage including injecting a hydrogen stream into a subsurface reservoir for storage during periods of low sales demand, mixing the hydrogen stream in the subsurface reservoir with a stored gas, and removing the hydrogen from the subsurface reservoir during high sales demand.

### BACKGROUND

Underground gas storage is a method to maintain a constant supply of a gas from a natural gas pipeline combined with a variable demand for the gas for an economic advantage. Because the gas consuming market is seasonal and critically fluctuates with the severity of weather, sufficient underground gas storage will allow the purchase and storage of the gas in low-demand periods, and the delivery of such gas to markets in the required volumes in periods of high demand.

Hydrogen gas has many uses in applications, such as use in the chemical industry, as a fuel for transport, as well as a means for energy storage. In order to be used in these applications, hydrogen gas may be stored through various means. Storage of hydrogen gas underground may be useful for stabilizing power grid output in the operation of intermittent energy sources, such as solar or wind power, as well as providing fuel for electricity generation and transportation. Methane may be stored for reasons similar to those for hydrogen. For instance, it may be stored for use in the chemical industry, fuel, for storing energy, or other reasons. Carbon dioxide may be stored for the purposes of long-term sequestration or other uses. However, storing these gases typically requires a large volume. For example, hydrogen is a low-density material; 1 kg of hydrogen gas occupies over 11 m³ at atmospheric pressure and room temperature. This means that a large amount of hydrogen necessarily requires a large volume to store under these conditions. This is true for methane, carbon dioxide, and other gases as well.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for storing hydrogen in a subsurface reservoir by injecting hydrogen into the reservoir during low sales demand, mixing the hydrogen with gas stored in the reservoir, and removing the hydrogen from the reservoir during higher demand.

Other aspects and advantages of the claimed subject matter will be apparent from the following description and the appended claims.

### BRIEF DESCRIPTION OF DRAWINGS

FIG. 1 is an illustration of a hydrogen storage system according to one or more embodiments herein.

### DETAILED DESCRIPTION

There is a demand for large volumes of hydrogen gas facilities and storage. Utilizing depleted oil and gas reservoirs, aquifers, and other subsurface formations may solve storage issues for large-scale subsurface storage of hydrogen gas. Storage sites in large volumes, such as at the subsurface formations in depleted oil fields, gas fields, deep saline, or other porous formations (shallow or deep) with appropriate seal and containment integrity may provide an easy to utilize, safe, and an efficient solution to hydrogen storage issues.

Underground gas storage projects around the world lack the flexibility to inject and re-produce simultaneously. Although few commercially available alternatives claim to provide switching between the two modes of operation in very short time (e.g., in a matter of minutes) to ensure short response time, none of these options currently has the simultaneous dual operation mode flexibility to inject and reproduce at the same time in different areas of the field. Accordingly, there exists a need for a subsurface gas storage method allowing hydrogen injection and storage during low gas demand and extraction during times of peak gas demand.

Gases, such as hydrogen, methane, ethane, and carbon dioxide may be stored, according to embodiments herein, in depleted gas reservoirs, shallow aquifers, or salt caverns. Utilizing existing infrastructure, these underground spaces may be converted to gas storage systems consisting of an inlet connected to a gas source, a membrane to selectively extract specific gases as needed in an outlet line, and a connection to a main gas supply line for simple industrial usage. The membrane specifically ensures carbon dioxide does not exit the subsurface storage during extraction of H2 or CH4. The membrane has a high selectivity to hydrogen and is encased in a robust cartridge system that can be placed into a well. The membrane is a dynamic downhole device that receives feedback from the return well. Based on the feedback received, the membrane can be relocated to a region having higher hydrogen concentration. The membrane is an adaptation of hydrogen-selective filters used in steam-methane reformers (SMRs).

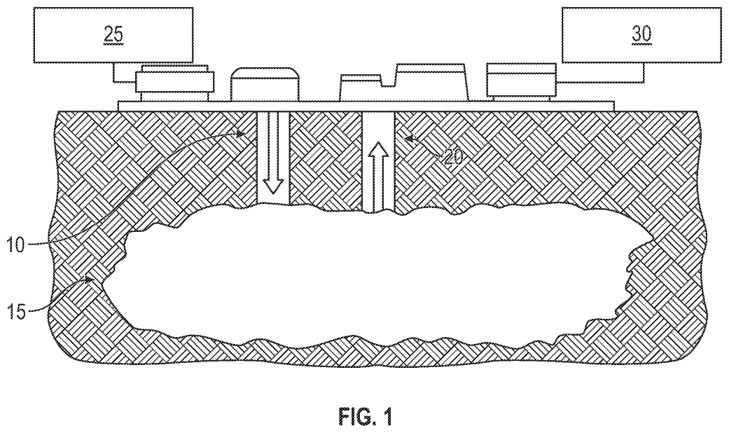

In this method, initially a hydrogen stream is injected into a subsurface reservoir for storage during periods of low H2 sales demand. This hydrogen stream is generated from various surface generation techniques, in-situ generation, and/or hydrogen sulfide conversion. Referring to FIG. 1, the hydrogen stream 10 is entering into the depleted gas reservoir. FIG. 1 illustrates the method using a depleted gas reservoir for the subsurface storage; however, shallow aquifers or salt caverns may also be used.

Hydrogen surface generation techniques include hydrogen extraction from processes and uses including grid power, coal, natural gas, methane, natural gas with carbon capture utilization and storage processes (CCUS), nuclear power, renewable energy, oil sands, and solar power. Thermal methods for producing hydrogen include gasification, steam methane reforming, and pyrolysis. Electric generation methods include electrolysis and high-temperature electrolysis.

Hydrogen can be generated in-situ by the addition of oxygen or air into the subsurface reservoir. This in-situ generation process will react with the natural gas in the subsurface reservoir to produce H2O. The hydrogen can be extracted from the H2O using electrolysis or chemical reactions with other compounds in the subsurface reservoir.

Hydrogen sulfide conversion is a process to remove hydrogen sulfide emissions from the air released by crude petroleum, natural gas, volcanic gases, liquid manure, sewage sludge, landfills, and sulfur hot springs. This conversion process results in water and sulfur dioxide. Through electrolysis or chemical reactions with other compounds, water can be broken down to oxygen and hydrogen.

Once obtained from any suitable source, the hydrogen stream mixes in the subsurface reservoir with a gas already present within the reservoir at the time of injection. The gas already present within the reservoir is a mixture of methane, ethane, and carbon dioxide. For example, the mixture within the depleted gas reservoir 15 is 10-40% hydrogen, 20-40% methane, and 20-40% ethane mixture. The volume percentage of hydrogen in the subsurface reservoir gas mixture ranges typically from 10-30%. The hydrogen stream is mixed into the gas already present within the reservoir using a system of in situ agitators, instrumentation, and controls to ensure the mixture is homogeneous. In some embodiments, the hydrogen can be mixed with mixture of methane and ethane using ex situ agitators prior to being injected into the reservoir.

The hydrogen, or other stored gas, is extracted as needed during periods of high sales demand. As shown in FIG. 1, the gas is extracted through return well 20 and feeds existing gas transportation infrastructure for simplified access. Gas production is forecasted to oscillate seasonally, with peak demand expected during the summer months and lowest demand, or “off peak”, during the winter. During peak demand, hydrogen may be recovered and sent to downstream processes 30 for utilization. During low demand, hydrogen may be fed from an outside source to the subsurface storage 25. The term “gas production” means the amount of gas being extracted from subsurface storage. The term “existing gas transportation infrastructure” refers to an established system that connects and transports a gas supply to industrial or residential uses.

According to one or more embodiments, hydrogen may be stored in man-made structures in salt formations called salt caverns. These salt formations have low permeability to the stored gas, such as, for example, 10⁻⁶ to 10⁻⁹ md, allowing for gas under pressure to remain in a cavern for long periods. Low permeability of salt formations facilitates the storage of gas within a salt cavern produced within them. In one or more embodiments, the permeability of the formation may be less than about 10⁻¹⁵ m². In one or more embodiments, the permeability of the formation may have a range with an upper limit of any one of 10⁻¹⁵ m², 10⁻¹⁸ m², or 10⁻²¹ m². In one or more embodiments, the permeability of the formation may range from about 10⁻¹⁵ m² to less than 10⁻²¹ m². This allows for storage of gas, as salt caverns are typically made to have volumes ranging from about 100,000 m³ to about 5,000,000 m³. Larger or smaller volumes are possible in some embodiments. Other embodiments may have volumes from about 200,000 m³ to about 3,000,000 m³. Still other embodiments may have volumes ranging from about 500,000 m³ to about 1,000,000 m³. In a salt cavern, the hydrogen may be stored in either a gaseous or solid state.

In other embodiments, hydrogen may be stored in an aquifer. An aquifer is an underground layer of water-bearing permeable rock, rock fractures, or unconsolidated materials. A shallow aquifer is an aquifer that is less than 500 feet deep. In a shallow aquifer, the hydrogen may be stored in either a gaseous or solid state.

In other embodiments, hydrogen may be stored in a depleted gas reservoir. A depleted gas reservoir can be defined as a reservoir in subsurface sand or rock formation that has previously produced oil or gas and is used for storing natural gas. A depleted gas reservoir is capable of storing injected natural gas in the pore spaces between grains without migrating or being lost into surrounding formations. The rock formation of the depleted reservoir should be capable of withstanding the repeated cycle of pressure changes during injection and extraction of the gas. In a depleted gas reservoir, the hydrogen must be stored in a gaseous state.

Embodiments herein thus provide a method and system for the efficient storage of large volumes of gas, which may be repeatedly withdrawn and replenished, for use in various energy conversion or chemical conversion processes.

One or more embodiments of the invention may provide at least one of the following advantages:
1) This subsurface storage provides an existing location to store large quantities of hydrogen in a cost-efficient way rather than having to develop new storage facilities;
2) This subsurface storage provides an accessible source of hydrogen gas during peak gas demand;
3) This subsurface storage provides a location to store, in mixture with hydrogen, carbon dioxide emissions to reduce negative impact of carbon dioxide emissions in the environment.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for subsurface gas storage comprising:
injecting a hydrogen stream into a subsurface reservoir for storage during periods of low sales demand;
mixing the hydrogen stream in the subsurface reservoir with a stored gas comprising methane, ethane, carbon dioxide, or mixtures thereof to create a hydrogen enriched gas; and
removing the hydrogen from the subsurface reservoir during periods of high sales demand.

2. The method of claim 1, wherein the subsurface reservoir is connected to an existing gas transportation infrastructure for simplified access.

3. The method of claim 1, wherein the type of subsurface reservoir is selected from the group consisting of a salt cavern, a depleted gas reservoir, and a shallow aquifer.

4. The method of claim 3, further comprising storing the hydrogen in a gaseous state.

5. The method of claim 1, wherein the hydrogen enriched gas contains 10-30% hydrogen by volume.

6. The method of claim 1, further comprising collecting the hydrogen stream from one or more of a plurality of surface generation techniques, in-situ generation, and hydrogen sulfide conversion processes.

7. The method of claim 1, wherein the mixing further comprises mixing the hydrogen and stored gas via in situ agitators to ensure a homogenous subsurface mixture.

8. The method of claim 1, wherein the removing further comprises extracting hydrogen using a membrane to selectively withdraw hydrogen without removing methane, ethane, carbon dioxide, or mixture thereof, from the stored gas.
